(19) United States
(12) Patent Application Publication
(10) Pub. No.: US 2024/0303699 A1
(43) Pub. Date: Sep. 12, 2024

(54) DONATION MANAGEMENT SYSTEM AND USER DEVICE

(71) Applicant: TOYOTA JIDOSHA KABUSHIKI KAISHA, Toyota-shi (JP)

(72) Inventors: Kanako AIDA, Inuyama-shi (JP); Sayumi MIYAZAKI, Inazawa-shi (JP); Izumi SUGIYAMA, Nagoya-shi (JP); Koki KAWAMURA, Nagoya-shi (JP); Yohei KOIKE, Nagoya-shi (JP); Koji NISHI, Nagoya-shi (JP); Atsushi SAJIKI, Okazaki-shi (JP)

(73) Assignee: TOYOTA JIDOSHA KABUSHIKI KAISHA, Toyota-shi (JP)

(21) Appl. No.: 18/429,638

(22) Filed: Feb. 1, 2024

(30) Foreign Application Priority Data
Mar. 6, 2023 (JP) 2023-033469

(51) Int. Cl. G06Q 30/0279; G01C 21/34

(52) U.S. Cl. CPC G06Q 30/0279; G01C 21/3469

(57) ABSTRACT

The donation management system includes a mobile terminal (user device) and a server. The mobile terminal is carried by the user and includes a GPS module capable of obtaining the user's travel route. The server is configured to communicate with the mobile terminal. The server transmits a plurality of routes including a normal route and an eco route that contributes to reducing environmental load more than the normal route to the mobile terminal. The server acquires the user's travel route through communication with the mobile terminal. The server also makes a donation to a specific account managed by the social contribution company when the user's travel route indicates that the user has traveled according to an eco route.

### CROSS-REFERENCE TO RELATED APPLICATION

This application claims priority to Japanese Patent Application No. 2023-033469 filed on Mar. 6, 2023, incorporated herein by reference in its entirety.

### BACKGROUND

### 1. Technical Field

The present disclosure relates to a donation management system and a user device.

### 2. Description of Related Art

Japanese Unexamined Patent Application Publication No. 2013-130918 (JP 2013-130918 A) discloses a server. When a member actually travels along an economical route that contributes to reducing an environmental load instead of a normal route, the server provides the member with a special privilege that can be enjoyed at a store on the economical route.

In the system described in JP 2013-130918 A, the special privilege provided to the user as an individual serves as a reward for reducing an environmental load. Some users do not seek for special privileges for the users as individuals. Other users are considered to think much of making social contributions. Thus, there is a desire for a system that satisfies users that desire to make social contributions while contributing to reducing environmental loads.

### SUMMARY

The present disclosure has been made in order to address the above issue, and therefore has an object to provide a donation management system and a user device capable of satisfying users that desire to make contributions to social contribution business operators while contributing to reducing environmental loads.

A first aspect of the present disclosure provides a donation management system including:
a user device carried by a user and including a global positioning system (GPS) module capable of acquiring a travel route of the user; and
a server configured to communicate with the user device.
   The server is configured to:
transmit a plurality of routes including a normal route and an economical route that contributes to reducing an environmental load more than the normal route to the user device; acquire the travel route of the user through communication with the user device; and
make a donation to a specific account managed by a social contribution business operator when the travel route of the user indicates that the user has moved along the economical route.

In the donation management system according to the first aspect of the present disclosure, as described above, a donation is made to a specific account managed by a social contribution business operator when the travel route of the user indicates that the user has moved along the economical route. Consequently, the user can not only contribute to reducing an environmental load but also contribute to a social contribution business operator through donations when the user moves along the economical route. This makes it possible to satisfy users that desire to make social contributions while contributing to reducing environmental loads.

In the donation management system according to the first aspect, preferably, the server transmits a route that contributes to promoting health of the user in addition to contributing to reducing the environmental load to the user device as the economical route. With this configuration, the user can promote health while making social contributions by moving along the economical route.

In the donation management system according to the first aspect, preferably, the server sets an employer of the user as an entity responsible for funds for donating to the specific account when the user moves along the economical route for business of the employer.

With this configuration, the user is not rendered responsible for donations when the user moves along the economical route for business purposes, which allows the user to move along the economical route more positively for business purposes.

In the donation management system according to the first aspect, preferably, the server sets the user as an entity responsible for funds for donating to the specific account when the user moves according to the economical route for a personal purpose. With this configuration, it is possible to suppress the employer etc. of the user from providing the funds for donations when the user moves along the economical route for personal purposes.

A second aspect of the present disclosure provides
a user device carried by a user, including:
a display that displays a plurality of routes including a normal route and an economical route that contributes to reducing an environmental load more than the normal route;
a GPS module that acquires a travel route of the user; and
a processor configured to output a command to make a donation to a specific account managed by a social contribution business operator when the user has moved along the economical route.

In the user device according to the second aspect of the present disclosure, as described above, a command to make a donation to a specific account managed by a social contribution business operator is output when the user has moved along the economical route. Consequently, it is possible to provide a user device capable of satisfying users that desire to make social contributions while contributing to reducing environmental loads.

According to the present disclosure, it is possible to satisfy users that desire to make social contributions while contributing to reducing environmental loads.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating the configuration of a donation management system according to an embodiment;

FIG. 2 is a diagram illustrating the configuration of a server according to an embodiment;

FIG. 3 is a diagram illustrating the configuration of a mobile terminal according to an embodiment;

FIG. 4 is a diagram illustrating an application screen of a mobile terminal according to an embodiment;

FIG. 5 is a sequence diagram illustrating control of a donation management system according to one embodiment;

FIG. 6 is a diagram showing a screen of a mobile terminal displaying donations (points);

FIG. 7 is a diagram showing a screen of a mobile terminal for changing the recipient of a donation; and

FIG. 8 is a diagram showing details of S16 in FIG. 5.

### DETAILED DESCRIPTION OF EMBODIMENTS

Hereinafter, an embodiment of the present disclosure will be described in detail with reference to the drawings. In the drawings, the same or corresponding parts are denoted by the same reference signs and the description thereof will not be repeated.

### Embodiment

### System Configuration

FIG. 1 is a diagram schematically showing the overall configuration of a donation management system according to an embodiment of the present disclosure. The donation management system 100 includes a server 1 and a plurality of mobile terminals 3. The server 1 is a server that typically manages an application 333, which will be described later. Note that the mobile terminal 3 is an example of a “user device” of the present disclosure.

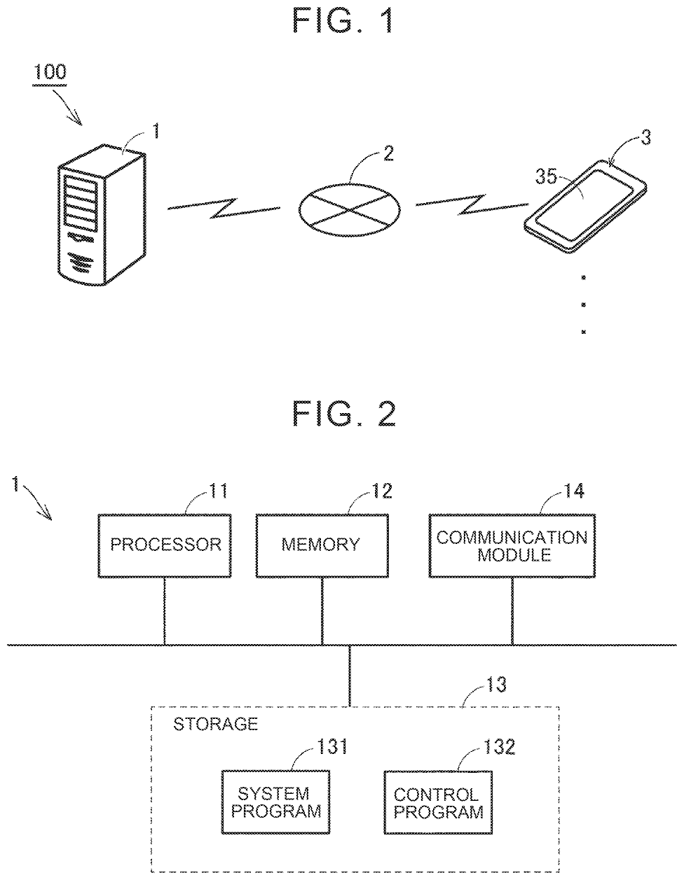

FIG. 2 is a diagram showing an example of the configuration of the server 1. Server 1 includes, for example, processor 11, memory 12, storage 13 and communication module 14.

The processor 11 is, for example, a microprocessor such as a Central Processing Unit (CPU) or a Micro-Processing Unit (MPU). Memory 12 is volatile memory such as Random Access Memory (RAM). The processor 11 reads out a system program 131 and a control program 132 (described later), expands them into the memory 12, and executes them, thereby realizing various processes.

The storage 13 is a rewritable nonvolatile memory such as a hard disk drive (HDD), solid state drive (SSD), or flash memory. The storage 13 stores a system program 131 including an Operating System (OS) and a control program 132 including computer-readable codes necessary for control calculations.

Communication module 14 includes a communication interface with a network such as the Internet 2 (see FIG. 1). The communication module 14 is configured to be capable of bidirectional communication with external devices (such as a plurality of mobile terminals 3) of the server 1. For example, the communication module 14 may receive position information of the mobile terminal 3 based on the GPS module 36 (described later) from each of the plurality of mobile terminals 3 at predetermined time intervals.

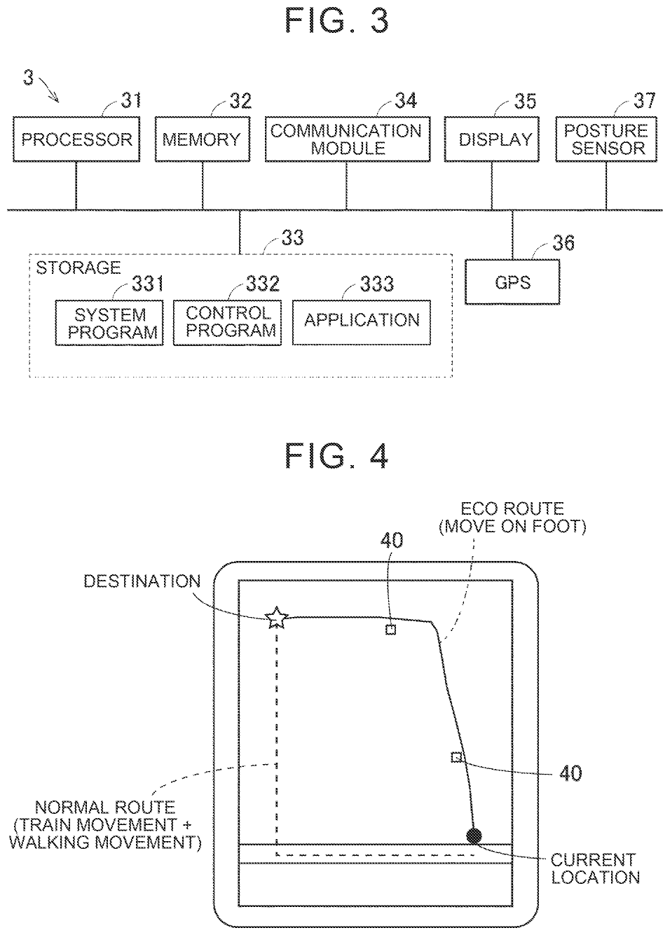

FIG. 3 is a diagram showing an example of the configuration of the mobile terminal 3. The mobile terminal 3 is a terminal carried by a user, and is, for example, a smartphone, a tablet, or a smart watch. The mobile terminal 3 may be a notebook personal computer (PC). The mobile terminal 3 includes, for example, a processor 31, a memory 32, a storage 33, a communication module 34, a display 35, a Global Positioning System (GPS) module 36, and an attitude sensor 37.

Processor 31 is, for example, a microprocessor such as a CPU or MPU. The memory 32 is a volatile memory such as RAM. The processor 31 implements various processes by reading out a system program 331, a control program 332, and an application 333 (described later), loading them onto the memory 32, and executing them.

The storage 33 is a rewritable non-volatile memory such as flash memory. The storage 33 stores a system program 331 including an OS, a control program 332 including computer-readable codes necessary for control calculations, and an application 333. Details of the application 333 will be described later.

Communication module 34 includes a communication interface conforming to wireless communication standards. The wireless communication standard may be Long Term Evolution (LTE) such as 4G or 5G, wireless Local Area Network (LAN) such as Wireless Fidelity (Wi-Fi), or both of these. The communication module 34 is configured to allow two-way communication with the server 1.

The display 35 is a mobile display such as organic electroluminescence (EL) or liquid crystal. The display 35 is configured to display various information according to control commands from the processor 31. In this example, the display 35 is a display with a touch panel capable of accepting user input operations.

The GPS module 36 acquires information (GPS information) indicating the current position of the mobile terminal 3 based on signals from a plurality of artificial satellites, and outputs the GPS information to the processor 31. Thereby, the GPS module 36 can acquire information on the user's travel route. Note that the mobile terminal 3 may include a beacon receiver (not shown) instead of or in addition to the GPS module 36.

The attitude sensor 37 is, for example, a 3-axis acceleration sensor, a 3-axis gyro sensor, or a geomagnetic sensor. The attitude sensor 37 detects the attitude (rotational movement) of the mobile terminal 3 and outputs the detection result to the processor 31.

### Application

FIG. 4 is a diagram showing an example of the display mode of the display 35 when the application 333 is executed. When the user inputs a destination in the application 333, multiple routes between the user's current location and the destination are displayed on the display 35. The plurality of routes are calculated (determined) by the server 1 (processor 11). Information on a plurality of routes is transmitted from the server 1 to the mobile terminal 3.

The plurality of routes include a normal route and an eco route. For example, the server 1 calculates the route that takes the shortest time to reach the destination as the normal route. Further, the normal route may be a route set in advance by the user. In the example shown in FIG. 4, the normal route is a route that includes traveling by train and traveling on foot to the destination. Note that a travel route by car may be displayed as the normal route.

Furthermore, the server 1 calculates a route that contributes to reducing environmental load more than the normal route as an eco route. The eco route may be a route that contributes to promoting the user's health in addition to reducing environmental load. For example, the server 1 calculates a route that involves only walking (or cycling) as an eco route. Furthermore, the server 1 may calculate a route longer than the shortest distance route to the destination as an eco route. The server 1 may calculate a route that takes longer time than the shortest time to reach the destination as an eco route. Furthermore, among a plurality of routes to the destination, a route with relatively many uphill slopes may be calculated as an eco route (health promotion route). Note that the method for selecting an eco route is not limited to the above example.

Furthermore, the server 1 extracts stores 40 that exist on the calculated eco route and are registered as stores that contribute to reducing environmental load. Thereby, the store 40 is displayed on the screen of the mobile terminal 3 where the eco route is displayed.

The server 1 also acquires the user's travel route through communication with the mobile terminal 3. Specifically, the server 1 acquires information on the user's travel route based on information from the GPS module 36 of the mobile terminal 3.

Here, in conventional systems, when a user contributes to reducing the environmental load, it is common for the user to be given a benefit service (points, etc.) as a reward. There are also users who do not aim to provide special benefits to individual users, but instead place emphasis on social contribution. For such users, it is conceivable that sufficient satisfaction cannot be obtained from special privilege services provided to individual users. Therefore, there is a need for a system that satisfies users who wish to contribute to society while contributing to the reduction of environmental burden.

In this embodiment, the server 1 makes a donation to a specific account managed by a social contribution company when the user's travel route indicates that the user has traveled according to an eco route. Points are accumulated for each user in a specific account. When the user moves according to the eco route, points are given to the specific account from predetermined funds. The above-mentioned predetermined funds will be described later.

Furthermore, when the user moves along the eco route, the server 1 may determine points to be donated based on the distance of the eco route and the like. Further, the server 1 may determine points to be donated according to the amount paid at the store 40.

### Sequence Control of Donation Management System

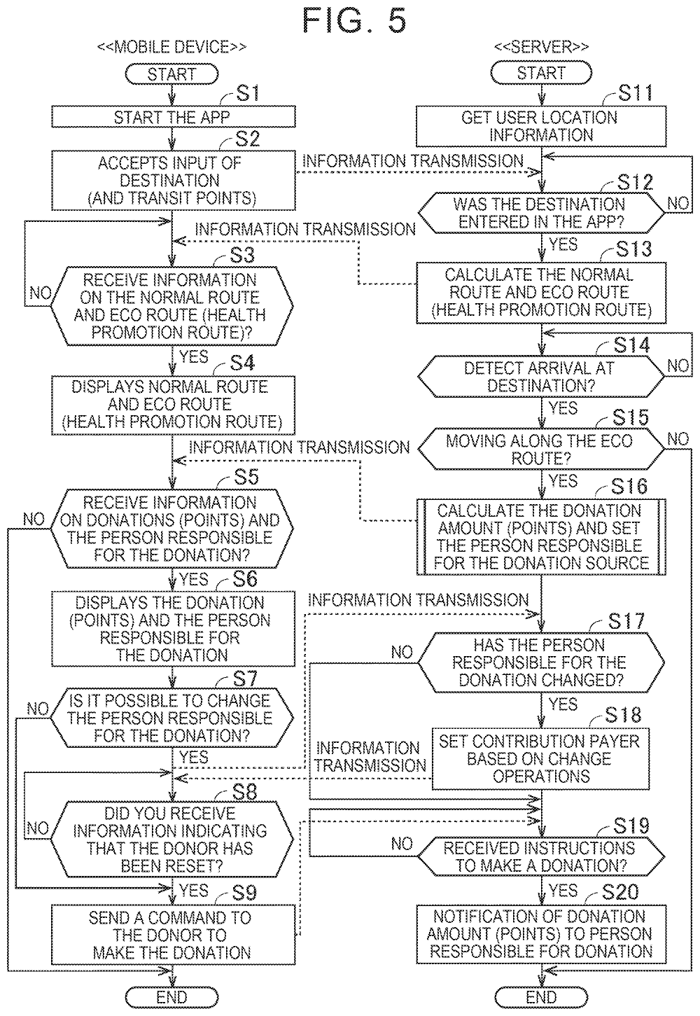

An example of sequence control executed by the donation management system 100 will be described with reference to FIG. 5.

In S1, the processor 31 of the mobile terminal 3 (hereinafter abbreviated as “mobile terminal 3”) starts the application 333 in response to a user's operation.

In S2, the mobile terminal 3 receives input of a destination from the user in the application 333. Note that, if there is an input of a transit point, the mobile terminal 3 also accepts the input of the transit point. The input information such as the destination is transmitted to the server 1 through the communication module 34 of the mobile terminal 3.

In S11, the processor 11 of the server 1 (hereinafter abbreviated as “server 1”) acquires the user's location information based on the information of the GPS module 36. Note that the process of S11 may be continuously executed at predetermined time intervals (for example, every 1 second).

In S12, the server 1 determines whether a destination or a route point has been input in the application 333. If information such as a destination has been input in the process of S2 (Yes in S12), the process proceeds to S13. If information such as a destination has not been input (No in S12), the process of S12 is repeated.

In S13, the server 1 calculates a normal route and an eco route (health promotion route) to the destination. The calculated route information is transmitted to the mobile terminal 3 via the communication module 14.

In S3, the mobile terminal 3 determines whether information on the normal route and the eco route (health promotion route) has been received. If the information on the normal route and the eco route has been received through the process in S13 (Yes in S3), the process advances to S4. If the information on the normal route and the eco route has not been received (No in S3), the process in S3 is repeated.

In S4, the mobile terminal 3 displays the received normal route and eco route (health promotion route) on the display 35 (see FIG. 4).

In S14, the server 1 determines whether the user has reached the destination based on the information of the GPS module 36 of the mobile terminal 3. If the user has reached the destination (Yes in S14), the process proceeds to S15. If the user has not reached the destination (No in S14), the process of S14 is repeated.

In S15, the server 1 determines whether the user has moved along the eco route based on the history of information in the GPS module 36 of the mobile terminal 3. If the user moves along the eco route (Yes in S15), the process proceeds to S16. If the user is not moving along the eco route (No in S15), the process ends.

The server 1 determines the user's means of transportation (walking, car, bicycle, train, etc.) based on the user's travel speed, travel route, travel time period, etc. obtained based on the information of the GPS module 36. Thereby, the server 1 determines whether the user has moved according to the movement method that reduces the environmental load calculated by the server 1.

In S16, the server 1 calculates the server 1 calculates the donation amount (points) to the social contribution business operator based on the movement by the user on the eco route, and determine a person responsible for funds for donation (hereinafter described as the person responsible for the donation). The method for determining the person responsible for the donation will be described later. The donation (points) and information on the person responsible for the donation are transmitted to the mobile terminal 3 through the communication module 14.

In S5, the mobile terminal 3 determines whether the donation (points) and the information on the donor have been received. If the donation (points) and the information on the bearer have been received (Yes in S5), the process proceeds to S6. If the donation (points) and the information on the bearer have not been received (No in S5), the process ends. Note that in S5, it may be determined whether the donation (points) and information on the person responsible for the donation have been received within a predetermined time (for example, within 5 minutes) after the user arrives at the destination.

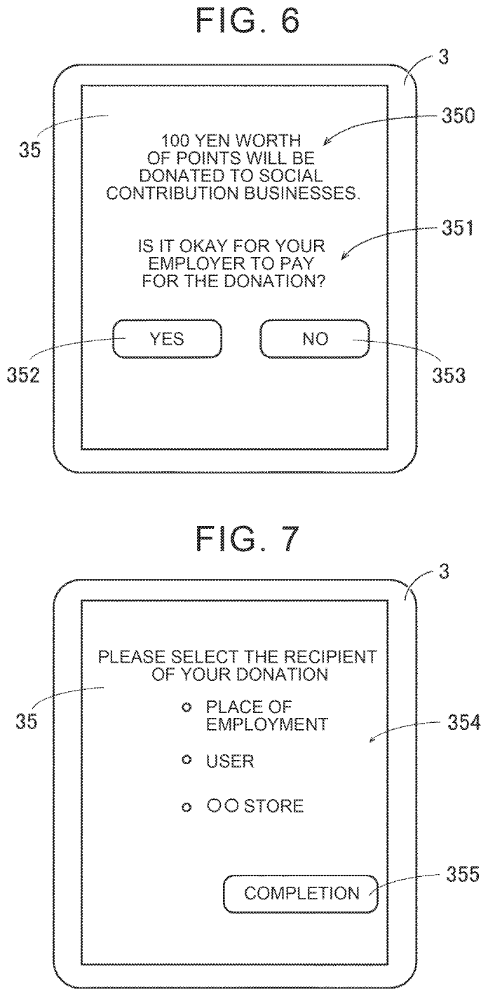

In S6, the mobile terminal 3 displays the donation amount (points) and the person responsible for the donation on the display 35 (see FIG. 6). FIG. 6 shows an example in which a message 50 indicating information regarding donations (points) is displayed on the display 35.

In the example shown in FIG. 6, a message 351 indicating the person responsible for the donation is displayed on the screen displaying the donation (points). In FIG. 6, it is shown that the burden bearer is the user's employer.

Further, on the screen shown in FIG. 6, a selection button 352 for indicating the intention to accept the contribution shown in the message 351 is displayed. The selection button 352 has “Yes” written therein. Further, on the screen shown in FIG. 6, a selection button 353 for indicating an intention not to accept the donation burden is displayed. The selection button 353 has “No” written therein.

Note that the mobile terminal 3 may be able to display on the display 35 the recipients of donations and the history of donations (points) to date.

When the selection button 353 is selected, the display 35 displays a screen 354 (see FIG. 7) for changing the donor. In the example shown in FIG. 7, employer, user, and store 40 (xxx store) are displayed as options for the donor. If the button 355 labeled “Complete” is selected with any of the above options selected, the process of changing the donor in the mobile terminal 3 is completed.

Referring again to FIG. 5, in S7, the mobile terminal 3 determines whether an operation to change the person responsible for the donation has been accepted. If the selection button 353 (see FIG. 6) is selected and the donor is changed on the screen shown in FIG. 7 (Yes in S7), the process proceeds to S8. In this case, the changed donation bearer information is transmitted to the server 1 through the communication module 34. If the selection button 352 (see FIG. 6) is selected and the donor is not changed (No in S7), the process proceeds to S9.

In S17, the server 1 determines whether the person responsible for the donation has been changed from the person set in S16. If the person responsible for the donation is changed in the process of S7 (Yes in S17), the process proceeds to S18. If the person responsible for the donation has not been changed (No in S17), the process advances to S19.

In S18, the server 1 sets (changes) the person responsible for the donation based on the user's operation to change the person responsible for the donation. Then, the server 1 transmits information indicating that the person responsible for the donation has been reset to the mobile terminal 3.

In S8, the mobile terminal 3 determines whether it has received information from the server 1 indicating that the person responsible for the donation has been reset. If the reset information is received (Yes in S8), the process proceeds to S9. If the reset information has not been received (No in S8), the process in S8 is repeated.

In S9, the mobile terminal 3 transmits a command to the server 1 to cause the donor to make a donation. The process then ends.

In S19, the server 1 determines whether a command to make a donation has been received from the mobile terminal 3. If the command is received through the process in S9 (Yes in S19), the process proceeds to S20. If the command has not been received (No in S19), the process in S19 is repeated.

In S20, the server 1 notifies the set donor of the donation (points) calculated in S16. The process then ends.

### Processing of S16

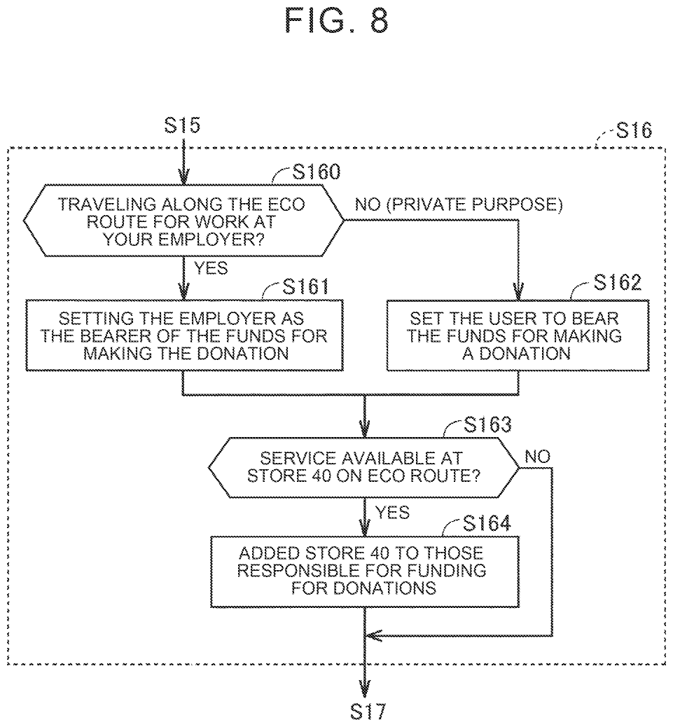

The details of the process in S16 will be explained with reference to FIG. 8. In S160, the server 1 determines whether the user has traveled along the eco route for work at the employer. If the user moves along the eco route for business purposes (Yes in S160), the process proceeds to S161. If the user moves along the eco route for personal purposes (No in S160), the process proceeds to S162.

The server 1 determines that the user has moved for business purposes based on the fact that, for example, an employer or a business partner of the employer has been input as the destination, or that the current location (departure point) is an employer or business partner. Further, the server 1 may determine whether the travel is for business purposes based on the time, day of the week, or the like. Note that the above determination may be performed using a trained model generated by machine learning technology such as deep learning.

In S161, the server 1 sets the person responsible for the donation as the employer. Next, the process advances to S163.

In S162, the server 1 sets the user as the bearer of the donation. Next, the process advances to S163.

In S163, the server 1 determines whether the user has used the service at the store 40 on the eco route. If the user is using the service at the store 40 (Yes in S163), the process advances to S164. If the user is not using the service at the store 40 (No in S163), the process proceeds to S17 (see FIG. 5).

The server 1 determines whether the user has used the service at the store 40 based on the information of the GPS module 36 of the mobile terminal 3. Further, the server 1 may determine whether the user has used a service at the store 40 based on the usage history of electronic money or credit using the mobile terminal 3.

In S164, the server 1 adds the store 40 where the user used the service as a donor. Next, the process advances to S17.

As described above, in the present embodiment, the server 1 makes a donation to a specific account managed by a social contribution company when the user's travel route indicates that the user has traveled along an eco route. This allows users to contribute to society by making donations to social contribution businesses while contributing to reducing environmental burden by traveling along the eco route. As a result, users can make a double contribution through the use of the economical route. This makes it possible to increase the satisfaction level of users who are highly interested in contributing to society, compared to the case where points or the like are given to the users themselves as rewards for reducing environmental load.

In the embodiment described above, an example has been shown in which a route that contributes to promoting the user's health in addition to contributing to environmental load reduction is calculated as an eco route, but the present disclosure is not limited to this. An eco route may be selected based only on whether it contributes to reducing environmental load.

In the above embodiment, there is a control that sets the person who will bear the donation to the employer when the person moves on the eco route for work at the place of employment, and a control that sets the person who pays the donation to the user when the person moves the eco route for personal purposes. An example in which control is performed is shown. This disclosure is not limited thereto. Only one of the above two controls may be performed. Furthermore, neither of the above two controls may be performed. For example, the person responsible for the donation may be fixed to the user (or employer).

In the embodiment described above, an example was shown in which a signal instructing a notification to make a donation to the person responsible for the donation is transmitted from the mobile terminal 3 to the server 1. This disclosure is not limited thereto. For example, once the setting of the recipient of the donation is completed, the server 1 may make the above notification even without a command from the mobile terminal 3.

In the embodiment described above, when the service at the store 40 is used while traveling on the eco route for business and while traveling on the eco route for personal purposes, the store 40 is added to the list of contributors of donations. This disclosure is not limited thereto. If the service at the store 40 is used only while traveling on the eco route for business or while traveling on the eco route for personal purposes, the store 40 may be added to the list of contributors to the donation.

The embodiments disclosed this time should be considered to be illustrative in all respects and not restrictive. The scope of the present disclosure is indicated by the claims rather than the description of the embodiments described above, and includes all changes within the range equivalent to the claims.

What is claimed is:

1. A donation management system comprising:
a user device carried by a user and including a global positioning system (GPS) module capable of acquiring a travel route of the user; and
a server configured to communicate with the user device, wherein the server is configured to:
transmit a plurality of routes including a normal route and an economical route that contributes to reducing an environmental load more than the normal route to the user device;
acquire the travel route of the user through communication with the user device; and
make a donation to a specific account managed by a social contribution business operator when the travel route of the user indicates that the user has moved along the economical route.

2. The donation management system according to claim 1, wherein the server transmits a route that contributes to promoting health of the user in addition to contributing to reducing the environmental load to the user device as the economical route.

3. The donation management system according to claim 1, wherein the server sets an employer of the user as an entity responsible for funds for donating to the specific account when the user moves along the economical route for business of the employer.

4. The donation management system according to claim 1, wherein the server sets the user as an entity responsible for funds for donating to the specific account when the user moves according to the economical route for a personal purpose.

5. A user device carried by a user, comprising:
a display that displays a plurality of routes including a normal route and an economical route that contributes to reducing an environmental load more than the normal route;
a GPS module that acquires a travel route of the user; and
a processor configured to output a command to make a donation to a specific account managed by a social contribution business operator when the user has moved along the economical route.
